(19) United States
(12) Patent Application Publication
(10) Pub. No.: US 2026/0074605 A1
(43) Pub. Date: Mar. 12, 2026

(54) POWER CONVERTER WITH INTEGRATED FIELD-EFFECT TRANSISTORS AND AN EXTERNAL PARALLEL FIELD-EFFECT TRANSISTOR

(71) Applicant: Cirrus Logic International Semiconductor Ltd., Edinburgh (GB)

(72) Inventors: Siddharth MARU, Austin, TX (US); Emmanuel A. MARCHAIS, Dripping Springs, TX (US); Markos KOSEOGLOU, Austin, TX (US); Marco A. JANKO, Austin, TX (US); Bryan W. MCCOY, Phoenix, AZ (US); Hasnain AKRAM, Austin, TX (US); Ilija JERGOVIC, Austin, TX (US); John L. MELANSON, Austin, TX (US); Changjong LIM, Chandler, AZ (US)

(73) Assignee: Cirrus Logic International Semiconductor Ltd., Edinburgh (GB)

(21) Appl. No.: 19/222,159

(22) Filed: May 29, 2025

Related U.S. Application Data
(60) Provisional application No. 63/693,909, filed on Sep. 12, 2024.

(51) Int. Cl. H02M 1/00; H02M 3/158

(52) U.S. Cl. CPC H02M 1/0054; H02M 3/158

(57) ABSTRACT

A system may include a power converter comprising an integrated circuit comprising a plurality of integrated switches for the power converter and an external switch external to the integrated circuit and electrically coupled to a first integrated switch of the plurality of integrated switches. The system may also include a controller electrically coupled to the plurality of integrated switches and the external switch and configured to control the integrated switches and the external switch, including opportunistically controlling the external switch to minimize power dissipation within the integrated circuit during operation of the power converter.

### RELATED APPLICATION

The present disclosure claims priority to U.S. Provisional Patent Application No. 63/693,909, filed Sep. 12, 2024, which is incorporated by reference herein in its entirety.

### FIELD OF DISCLOSURE

The present disclosure relates in general to circuits for electronic devices, including without limitation personal audio devices such as wireless telephones and media players, and more specifically, a power converter having integrated field-effect transistors and an external parallel field-effect transistor.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter), oftentimes as part of a power management integrated circuit (PMIC).

Power converters for low-to medium-power applications are increasingly integrated in integrated circuits. However, as power level increases, on-die power dissipation may be large enough to render integrated switches thermally unviable. Consequently, most medium-to high-power switching converters use discrete metal-oxide semiconductor field-effect transistors (MOSFETs), located externally to an integrated circuit for switching devices. However, using discrete components external to an integrated circuit may require a larger printed circuit board area. Thus, in many instances it would remain meaningful to find approaches of integrating components of a power converter within an integrated circuit.

### SUMMARY

In accordance with the teachings of the present disclosure, one or more disadvantages and problems associated with operation of power converters may be reduced or eliminated.

In accordance with embodiments of the present disclosure, a system may include a power converter comprising an integrated circuit comprising a plurality of integrated switches for the power converter and an external switch external to the integrated circuit and electrically coupled to a first integrated switch of the plurality of integrated switches. The system may also include a controller electrically coupled to the plurality of integrated switches and the external switch and configured to control the integrated switches and the external switch, including opportunistically controlling the external switch to minimize power dissipation within the integrated circuit during operation of the power converter.

In accordance with embodiments of the present disclosure, a method may include, for a power converter having an integrated circuit comprising a plurality of integrated switches for the power converter and an external switch external to the integrated circuit and electrically coupled to a first integrated switch of the plurality of integrated switches, controlling the integrated switches and the external switch, including opportunistically controlling the external switch to minimize power dissipation within the integrated circuit during operation of the power converter.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a circuit diagram of selected components of an example buck-boost power converter, in accordance with embodiments of the present disclosure;

FIG. 2 illustrates example waveforms for an input voltage and an output voltage of the power converter of FIG. 1 during charging and discharging phases, and sets forth example timing for turning an external switch of the power converter on and off with hysteresis, in accordance with embodiments of the present disclosure;

FIG. 3 illustrates example waveforms for an input voltage and an output voltage of the power converter of FIG. 1 when the input voltage is increasing and decreasing, and sets forth example timing for turning an external switch of the power converter on and off without hysteresis, in accordance with embodiments of the present disclosure;

FIGS. 4A and 4B illustrate example waveforms for transitioning of an integrated switch and an external switch of the power converter of FIG. 1 for safe transition around a buck-boost boundary of the power converter, in accordance with embodiments of the present disclosure;

FIG. 5 illustrates a circuit diagram of selected components of the example buck-boost power converter of FIG. 1, with detail of a controller for switches of the buck-boost power converter, in accordance with embodiments of the present disclosure;

FIG. 6 illustrates a circuit diagram of selected components of the example buck-boost power converter of FIG. 1, with greater detail of drivers for switches of the buck-boost power converter, in accordance with embodiments of the present disclosure; and

FIG. 7 illustrates a circuit diagram of selected components of an example buck-boost power converter, in accordance with embodiments of the present disclosure.

### DETAILED DESCRIPTION

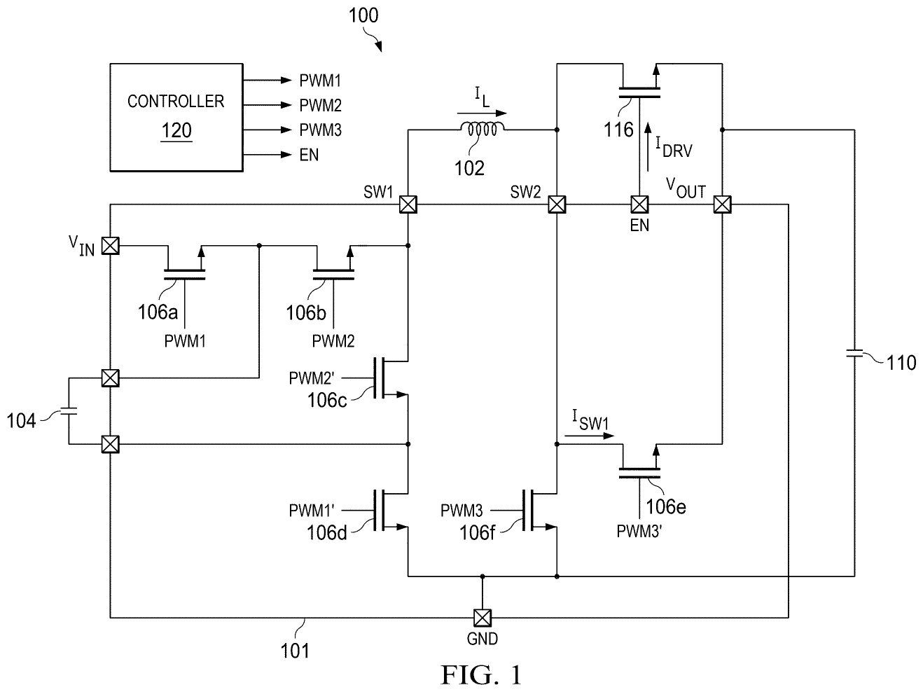

FIG. 1 illustrates a circuit diagram of selected components of an example buck-boost power converter 100, in accordance with embodiments of the present disclosure. As shown in FIG. 1, power converter 100 may comprise components internal to an integrated circuit 101 and components external to integrated circuit 101. In operation, power converter 100 may receive an input voltage V_{IN} on a pad of integrated circuit 101 and have an output configured to generate an output voltage V_{OUT} on an output capacitor 110 external to integrated circuit 101 based on switching signals PWM1, PWM2, and PWM3, which may comprise pulse-width modulation signals. Power converter 100 May 10 also include a power inductor 102 external to integrated circuit 101. In addition, power converter 100 may include a plurality of switches 106a, 106b, 106c, 106d, 106e, and 106f internal to integrated circuit 101, wherein switch 106a is coupled between the input and a first terminal of a flying capacitor 104 external to integrated circuit 101, switch 106b is coupled between the first terminal of flying capacitor 104 and a first switching node SW1 (wherein first switching node SW1 is coupled to a first terminal of power inductor 102), switch 106c is coupled between first switching node SW1 and a second terminal of flying capacitor 104, switch 106d is coupled between the second terminal of flying capacitor 104 and a ground voltage GND, switch 106e is coupled between a second switching node SW2 at a second terminal of power inductor 102 and the output, and switch 106f is coupled between second switching node SW2 at the second terminal of power inductor 102 and the ground voltage. In operation, switch 106a may be controlled by control signal PWM1, switch 106d may be controlled by a complement of control signal PWMI (e.g., PWM1′), switch 106b may be controlled by control signal PWM2, switch 106c may be controlled by a complement of control signal PWM2 (e.g., PWM2′), switch 106f may be controlled by control signal PWM3, and switch 106e may be controlled by a complement of control signal PWM3 (e.g., PWM3′), in order to drive a power inductor current I_{L} through power inductor 102 to regulate output voltage V_{OUT} to a desired target voltage. As shown in FIG. 1, switches 106a, 106b, 106c, 106d, 106e, and 106f may be implemented using field-effect transistors.

As also shown in FIG. 1, power converter 100 may include an external switch 116 external to integrated circuit 101, with external switch 116 being in parallel with switch 106c (i.e., switches 106c and 116 are drain-coupled and source-coupled). As shown in FIG. 1, external switch 116 may be implemented as a field-effect transistor. External switch 116 may be controlled by an enable signal EN. As described in greater detail below, external switch 116, when present, may only be enabled when a need for high power exists within power converter 100. However, when external switch 116 is disabled (e.g., in lower-power applications) or absent, the remaining components of power converter 100 (e.g., power inductor 102, flying capacitor 104, switches 106, and output capacitor 110) may still be used on a standalone basis to perform power conversion.

A controller 120 may be used to generate the various control signals PWM1, PWM2, PWM3, and enable signal EN. While shown external to integrated circuit 101 in FIG. 1, in some embodiments, controller 120 may be internal to integrated circuit 101.

While the presence of discrete external switch 116 in parallel with integrated converter switch 106e may aid in minimizing on-die thermal dissipation within integrated circuit 101, complex control schemes for detecting a high-power scenario, detecting the presence or absence of external switch 116, and turning on external switch 116 may be necessary. Further, external switch 116 is likely to have a high gate capacitance requiring a substantial amount of drive current to toggle at high frequencies. In addition, given that external switch 116 may be turned on only when a large amount of power is dissipated within power converter 100, it may be crucial to ensure that external switch 116 is present and enabled. Otherwise, a large amount of power may flow through internal switches 106 which could lead to excessive on-die power dissipation and damage.

Accordingly, controller 120 may be configured to regulate power through integrated circuit 101 by perturbing external switch 116, for example by driving its gate with enable signal EN, sensing any effect of such perturbation (e.g., changes in one or more of node voltages, currents, or switch impedances within power converter 100), and then controlling an amount of power consumed within integrated circuit 101 based on whether or not external switch 116 is present.

Controller 120 may perturb external switch 116 by driving a large current to the gate of external switch 116 to quickly enable external switch 116 or by gradually ramping current into gate of external switch 116. If external switch 116 is perturbed with driving of a large current to the gate of external switch 116, the presence or absence of external switch 116 may be detected in a number of ways, including: (a) sensing a reduction in impedance of the path of external switch 116, which may lead to an increase in output voltage V_{OUT} if external switch 116 is present: (b) a change in an amount of current I_{sw} flowing through switch 106e if external switch 116 is present: and/or (c) a change in impedance (e.g., impedance Z=(V_{OUT}−SW2)/I_{sw}) through the path of external switch 116 if external switch 116 is present.

If external switch 116 is perturbed with driving of a slow, gradual current into the gate of external switch 116, the presence or absence of external switch 116 may be detected based on an amount of capacitance (e.g.,

$$C = \frac{{dI}_{DRV} dT}{dEN} ,$$

wherein I_{DRV} is the current driven into the gate of external switch 116, and T is time) present on the pin of integrated circuit 101 driving the gate of external switch 116. A low capacitance may indicate absence of an external switch, while a high capacitance may indicate presence of external switch 116. Further, an amount of time taken to fully enable external switch 116 may be used as an estimate of a size of external switch 116. The amount of time needed to fully enable external switch 116 may be used to determine whether external switch 116 may be quickly toggled between its enabled and disabled states (e.g., at a rate substantially similar to that of switching of switch 106e), or whether external switch 116 may only be enabled opportunistically (e.g., at a rate substantially lower than that of switching of switch 106e).

If external switch 116 is detected, controller 120 may enable external switch 116 (provided other conditions for enablement exist, such as a high level of power being driven through power converter 100), allowing increased power to flow through power converter 100. On the other hand, if no external switch is detected, controller 120 may limit power being driven through power converter 100 to a level which may be safely handled by internal switches 106.

As shown in the table below, controller 120 may control switch 106e and external switch 116 to operate in various control modes, wherein one or more of the control modes (e.g., mode 1 in the table below) causes a tri-stated condition on the output of power converter 100, one or more of the control modes (e.g., modes 2, 3, and 4 in the table below) implements a boost-bypass function (e.g., as may occur during buck operation of power converter 100), one or more of the control modes (e.g., modes 5, 6, and 7 in the table below) may operate to operate power converter 100 in a boost mode, and one or more modes may be invalid modes which may not occur for practical reasons (e.g., modes 8 and 9 in the table below). In mode 7, controller 120 may control switch 106e and external switch 116 to switch synchronously with one another.

| Mode | Switch 106e | External Switch 116 | Function |
|---|---|---|---|
| 1 | Static Off | Static Off | Tri-stated Output |
| 2 | Static On | Static Off | Boost-Bypass |
| 3 | Static Off | Static On | Boost-Bypass |
| 4 | Static On | Static On | Boost-Bypass |
| 5 | Switching | Static Off | Boosted Output |
| 6 | Static Off | Switching | Boosted Output |
| 7 | Switching | Switching | Boosted Output |
| 8 | Static On | Switching | Invalid |
| 9 | Switching | Static On | Invalid |

However, despite these various available states, it may not be desirable or practical to operate in any of the modes (e.g., modes 5, 6, and 7) in which external switch 116 would switch to generate a boosted output. For example, controlling external switch 116 such that it switches fast enough may require a dedicated high-power driver, which would increase die area and quiescent current. Accordingly, controller 120 may operate external switch 116 in a “pseudo-static” manner, in which it does not switch very often. For example, controller 120 may operate external switch 116 such that external switch 116 is on during buck mode operation of power converter 100 and is otherwise off. Accordingly, controller 120 may use a low-current capability driver to turn external switch 116 on and off.

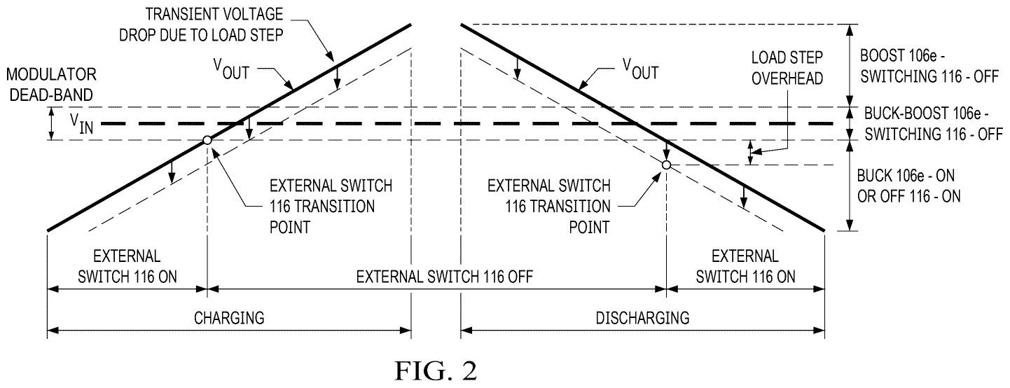

To that end, FIG. 2 illustrates example waveforms for input voltage V_{IN} and output voltage V_{OUT} during charging (e.g., magnetization) and discharging (e.g., demagnetization) phases, and sets forth example timing for turning external switch 116 on and off with hysteresis, in accordance with embodiments of the present disclosure.

FIG. 2 also illustrates example control of integrated switch 106e and external switch 116 across a buck-boost boundary of power converter 100. During the charging period controller 120 may transition external switch 116 from on to off when output voltage Vour rises above the lower end of a modulator dead band region, at which point output voltage VOLT may be slightly lower than input voltage VIN. After such point, controller 120 may cause integrated switch 106e to switch to cover buck-boost operation of power converter 100. During the discharging period, controller 120 may transition external switch 116 from off to on at a lower voltage than which it was transitioned during the charging period, due to a worst-case load step on output voltage V_{OUT}.

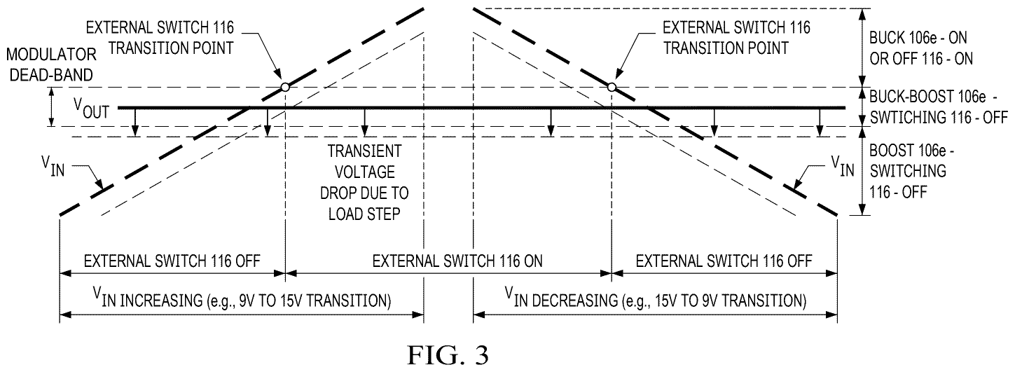

FIG. 3 illustrates example waveforms for input voltage V_{IN} and output voltage V_{OUT} when input voltage V_{IN} is increasing or decreasing, and sets forth example timing for turning external switch 116 on and off without hysteresis, in accordance with embodiments of the present disclosure. FIG. 3 also illustrates example control of integrated switch 106e and external switch 116 across a buck-boost boundary of power converter 100. With input voltage V_{IN} increasing, controller 120 may transition external switch 116 from off to on when input voltage V_{IN} rises above a higher end of a modulator dead band region, at which point input voltage V_{IN} may be slightly higher than output voltage V_{OUT}. With input voltage VIN decreasing, controller 120 may transition external switch 116 from on to off at such higher end of the modulator dead band region.

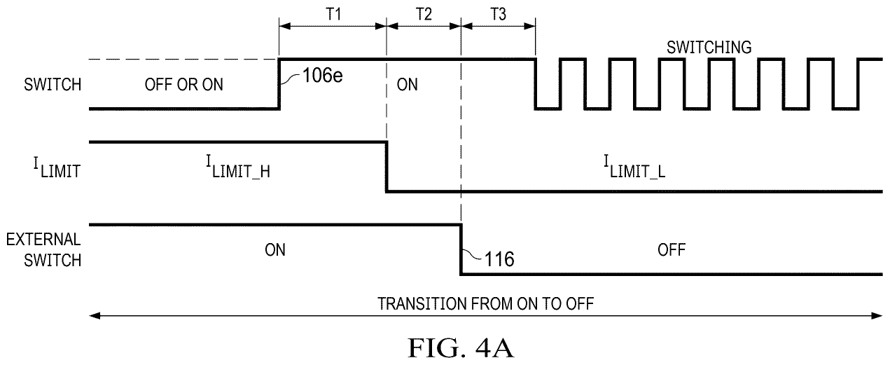

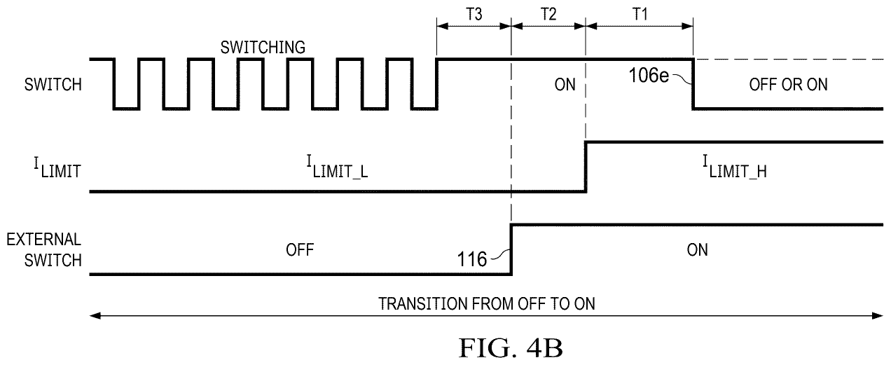

FIGS. 4A and 4B illustrate example waveforms for transitioning of integrated switch 106e and external switch 116 for safe transition around a buck-boost boundary of power converter 100, in accordance with embodiments of the present disclosure. For example, as shown in FIG. 4A, to safely transition around the buck-boost boundary in charging mode, controller 120 may initially turn on external switch 116 while turning off integrated switch 106e. At this point, power converter 100 may output current up to a maximum current limit of I_{LIMIT}=I_{LIMIT_H}. When a boundary condition is detected (e.g., output voltage V_{OUT} entering the modulator dead band), controller 120 may turn on integrated switch 106e. After a period T1 after turning on integrated switch 106e, controller 120 may decrease current limit I_{LIMIT} to a value of I_{LIMIT_L} lower than I_{LIMIT_H}. After another period of time T2, and once an output current of power converter 100 has settled below current limit value I_{LIMIT_L}, controller 120 may turn off external switch 116. After an additional period of time T3, and once external switch 116 is turned off, controller 120 may cause integrated switch 106e to switch (e.g., in boost mode operation).

Despite advantages of operating external switch 116 in a “pseudo-static” manner as described above, certain problems may occur within power converter 100 due to such operation. For example, current shoot-through may occur between external switch 116 and internal switch 106f during the buck-boost transition of power converter 100. As another example, gate retriggering of external switch 116 may occur due to fast switching of the portions of power converter 100 residing on integrated circuit 101, and because a low-current capability driver for driving external switch 116 may cause a weak pull-down of the gate-to-source voltage of external switch 116. Thus, during boost mode switching, a high slew rate of a switching node of power converter 100 may cause malfunction. As a further example, due to a reverse recovery characteristic of external switch 116 (e.g., a reverse diode present within the field-effect transistor implementing external switch 116), a high spike current may be induced, which could excite a parasitic inductance associated with external switch 116, creating a voltage differential between the gate and source terminals of external switch 116. Any or all of these issues could be destructive to the operation of power converter 100.

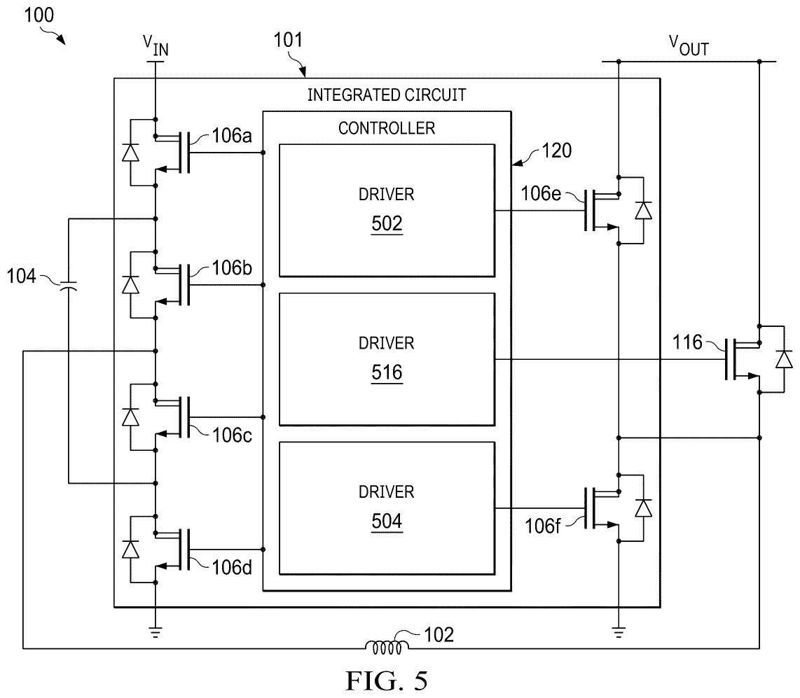

FIG. 5 illustrates a circuit diagram of selected components of power converter 100, with detail of controller 120 for switches 106 and 116 of power converter 100, in accordance with embodiments of the present disclosure. As shown in FIG. 5, controller 120 may be integral to integrated circuit 101, and may include a driver 502 for driving switch 106e, a driver 504 for driving switch 106f, and a driver 516 for driving external switch 116. Controller 120 may also include drivers for driving switches 106a, 106b, 106c, and 106d, but FIG. 5 excludes such drivers for purposes of clarity and exposition. In some embodiments, driver 516 may be substantially smaller than (and accordingly, substantially weaker than) driver 502.

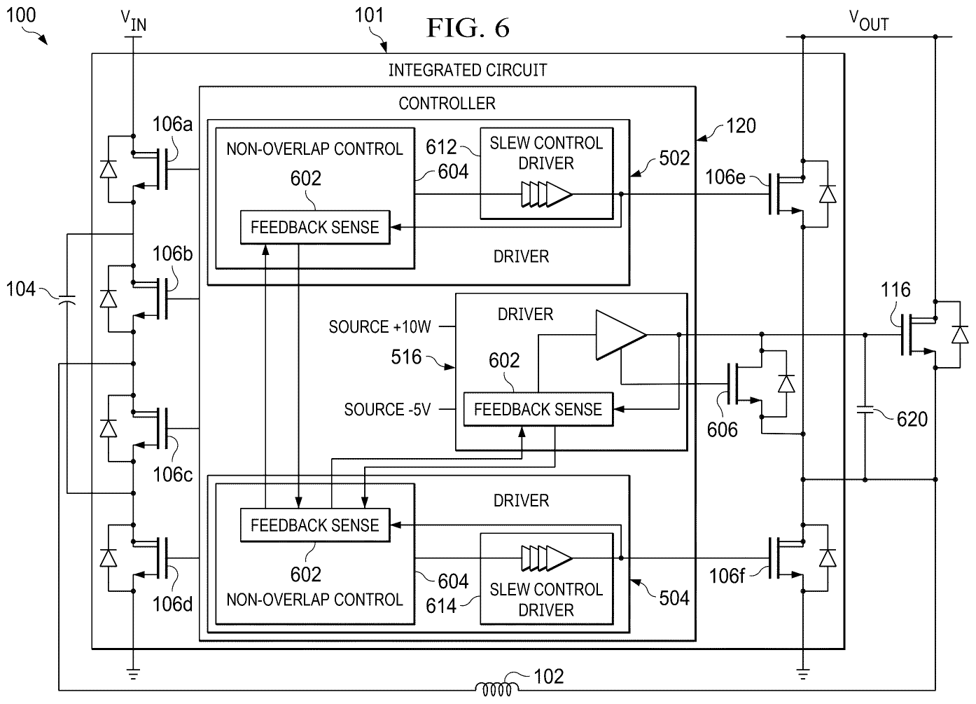

FIG. 6 illustrates a circuit diagram of selected components of power converter 100, with greater detail of drivers 502, 504, and 516 for switches 106 and 116 of the power converter 100, in accordance with embodiments of the present disclosure.

To overcome the shoot-through problem described above, controller 120 may implement a non-overlapping scheme between integrated switch 106f and external switch 116. To achieve this non-overlapping scheme, driver 516 may include feedback sensing subsystem 602 for sensing a gate voltage on external switch 116, that may be communicatively coupled to a non-overlap control subsystem 604 of driver 504. Non-overlap control subsystem 604 may provide control of integrated switch 106f such that switching of switch 106f may only be allowed when external switch 116 is fully off, thus ensuring shoot-through immunity.

To overcome the problem relating to the weak pull-down problem for external switch 116, integrated circuit 101 may include a pull-down device 606 (which may be implemented with a field-effect transistor). Controller 120 may control pull-down device 606 to turn on when external switch 116 is fully off (e.g., as may be sensed by feedback sensing subsystem 602) creating a low impedance between the gate and source terminals of external switch 116.

To overcome the problems relating to the weak pull-down of external switch 116 and reverse recovery current of external switch 116, driver 502 and driver 504 may include a slew control driver 612 and a slew control driver 614, respectively, to control current with respect to time in order to minimize spike currents and mitigate gate retriggering and diode destruction. Slew control drivers 612 and 614 may also provide additional benefit to pull-down device 606. In some embodiments, slew rates for slew control drivers 612 and 614 may be a function of whether external switch 116 is present. For example, the slew rates may be lower when external switch 116 is present and higher when external switch 116 is absent.

In addition or alternatively, to overcome the problems relating to the weak pull-down of external switch 116 and reverse recovery current of external switch 116, a capacitor 620 may be coupled between the gate and source terminals of external switch 116 to absorb drain-current caused by change in voltage. Capacitor 620 may act as a low-impedance pathway for a rapidly-changing signal, and may suppress a differential in the gate-to-source voltage of external switch 116.

In addition or alternatively, to overcome the problems relating to the weak pull-down of external switch 116 and reverse recovery current of external switch 116, driver 516 may include a negative supply rail, in order to ensure that the voltage driven by driver 516 to external switch 116 does not exceed the threshold voltage of external switch 116. Such approach may reduce or eliminate gate retriggering issues.

In addition or alternatively, to overcome the problem relating to the reverse recovery current of external switch 116, a Kelvin source ball may be used to couple driver 516 as close as possible to the source terminal of external switch 116. When the path through which the drain current of external switch flows is separated from the path in which the gate-source voltage is applied, the influence of the drain current may be reduced.

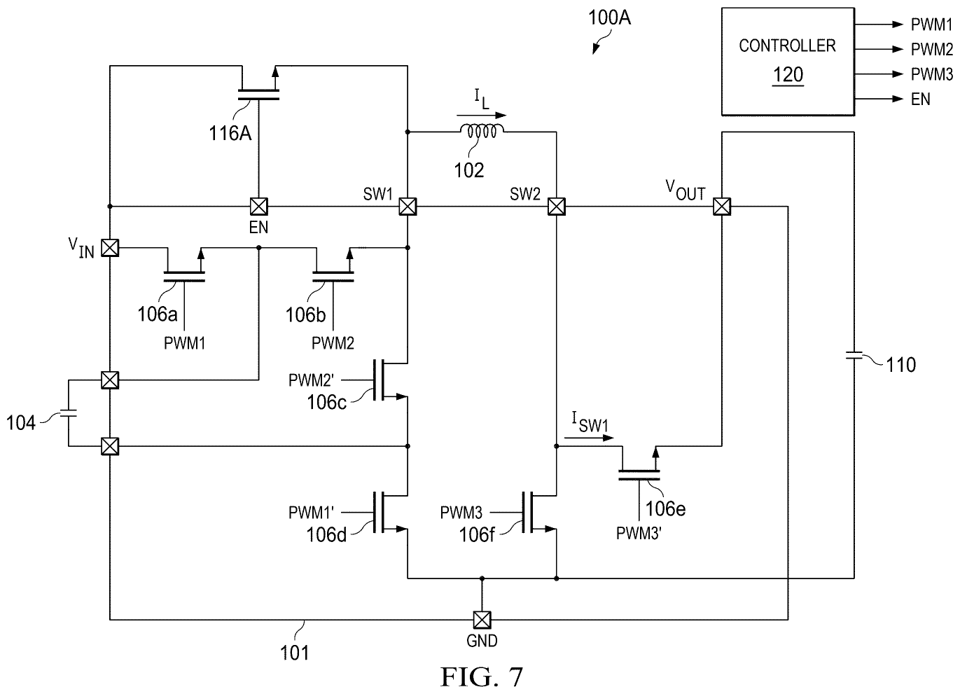

Although the foregoing contemplates external switch 116 in parallel with a particular integrated switch 106e, it is understood that an external switch similar or identical to that discussed above may be coupled to one or more other integrated switches in any suitable manner. For example, FIG. 7 illustrates a circuit diagram of selected components of another example buck-boost power converter 100A, in accordance with embodiments of the present disclosure. Power converter 100A may be similar in many respects to power converter 100 of the foregoing figures, except that power converter 100A may include an external switch 116A in parallel with the series combination of switches 106a and 106b. Thus, similar to that of power converter 100, external switch 116A may be subject to a pseudo-static control scheme to minimize power dissipation within integrated circuit 101. For example, external switch 116A may be turned on during a boost mode of power converter 100A and turned off during all other times.

In addition, it is understood that in some embodiments, a power converter may include multiple external switches. For example, in some embodiments, a power converter may include an external switch (e.g., external switch 116) in parallel with integrated switch 106e and an external switch (e.g., external switch 116A) in parallel with the series combination of switches 106a and 106b.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. A system comprising:
a power converter comprising:
an integrated circuit comprising a plurality of integrated switches for the power converter; and
an external switch external to the integrated circuit and electrically coupled to a first integrated switch of the plurality of integrated switches; and
a controller electrically coupled to the plurality of integrated switches and the external switch and configured to control the integrated switches and the external switch, including opportunistically controlling the external switch to minimize power dissipation within the integrated circuit during operation of the power converter.

2. The system of claim 1, wherein the controller is further configured to, during operation of the power converter, enable and disable the external switch at a first frequency significantly lower than a second frequency at which the controller enables and disables the first integrated switch.

3. The system of claim 1, wherein the controller is further configured to:
determine if the external switch is present within the power converter;
responsive to determining the external switch is present, control the power converter to limit current passing through the power converter to a first limit; and
responsive to determining the external switch is absent, control the power converter to limit current passing through the power converter to a second limit significantly lower than the first limit.

4. The system of claim 3, wherein the controller is further configured to determine if the external switch is present based on one or more of an impedance of an electrical path associated with the external switch and an amount of current flowing through the integrated switch.

5. The system of claim 3, wherein the controller is further configured to determine if the external switch is present and a size of the external switch based on a rate of change of a voltage on a gate terminal of the external switch in response to a fixed driving current to the gate terminal.

6. The system of claim 5, wherein the controller is further configured to determine, based on the size of the external switch, whether to control switching of the external switch at a rate substantially similar to that of switching of the first integrated switch or at a rate substantially smaller than that of switching of the first integrated switch.

7. The system of claim 1, wherein the external switch is in parallel with the integrated switch.

8. The system of claim 1, wherein:
the plurality of integrated switches further includes a second integrated switch; and
the external switch is in parallel with a series combination of the first integrated switch and the second integrated switch.

9. The system of claim 1, wherein the controller is integral to the integrated circuit.

10. The system of claim 1, wherein:
the integrated switch comprises a first field-effect transistor; and
the external switch comprises a second field-effect transistor.

11. The system of claim 1, wherein the controller is further configured to implement a non-overlap control scheme to minimize shoot-through current between the external switch and at least one integrated switch of the plurality of integrated switches.

12. The system of claim 1, further comprising a pull-down device configured to electrically couple a gate terminal of the external switch to another terminal of the external switch when the external switch is disabled.

13. The system of claim 1, wherein the controller is further configured to control a slew rate of a control signal of the first integrated switch as a function of whether the external switch is present.

14. The system of claim 11, wherein the controller is further configured to control a second slew rate of a second control signal of a first integrated switch of the plurality of integrated switches as a function of whether the external switch is present.

15. The system of claim 1, further comprising a capacitor external to the integrated circuit coupled between a gate terminal and another terminal of the external switch.

16. The system of claim 1, wherein the controller comprises a driver for driving a gate terminal of the external switch, further wherein the driver includes a negative supply rail.

17. The system of claim 1, wherein the controller comprises a driver for driving a gate terminal of the external switch, further wherein the driver is electrically coupled closely to a source terminal of the external switch.

18. The system of claim 1, wherein the controller comprises:
a first driver for driving a gate terminal of the first integrated switch; and
a second driver for driving a gate terminal of the external switch;
wherein the second driver is substantially smaller than the first driver.

19. A method comprising, for a power converter having an integrated circuit comprising a plurality of integrated switches for the power converter and an external switch external to the integrated circuit and electrically coupled to a first integrated switch of the plurality of integrated switches:
controlling the integrated switches and the external switch, including opportunistically controlling the external switch to minimize power dissipation within the integrated circuit during operation of the power converter.

20. The method of claim 19, further comprising, during operation of the power converter, enabling and disabling the external switch at a first frequency significantly lower than a second frequency at which the controller enables and disables the first integrated switch.

21. The method of claim 19, further comprising:
determining if the external switch is present within the power converter;
responsive to determining the external switch is present, controlling the power converter to limit current passing through the power converter to a first limit; and
responsive to determining the external switch is absent, controlling the power converter to limit current passing through the power converter to a second limit significantly lower than the first limit.

22. The method of claim 21, further comprising determining if the external switch is present based on one or more of an impedance of an electrical path associated with the external switch and an amount of current flowing through the integrated switch.

23. The method of claim 21 further comprising determining if the external switch is present and a size of the external switch based on a rate of change of a voltage on a gate terminal of the external switch in response to a fixed driving current to the gate terminal.

24. The method of claim 23, further comprising determining, based on the size of the external switch, whether to control switching of the external switch at a rate substantially similar to that of switching of the first integrated switch or at a rate substantially smaller than that of switching of the first integrated switch.

25. The method of claim 19, wherein the external switch is in parallel with the integrated switch.

26. The method of claim 19, wherein:
the plurality of integrated switches further includes a second integrated switch; and
the external switch is in parallel with a series combination of the first integrated switch and the second integrated switch.

27. The method of claim 19, wherein the controlling is performed by a controller integral to the integrated circuit.

28. The method of claim 19, wherein:
the integrated switch comprises a first field-effect transistor; and
the external switch comprises a second field-effect transistor.

29. The method of claim 19, further comprising implementing a non-overlap control scheme to minimize shoot-through current between the external switch and at least one integrated switch of the plurality of integrated switches.

30. The method of claim 19, further comprising electrically coupling a gate terminal of the external switch to another terminal of the external switch with a pull-down device when the external switch is disabled.

31. The method of claim 19, further comprising controlling a slew rate of a control signal of the first integrated switch as a function of whether the external switch is present.

32. The method of claim 19, further comprising controlling a second slew rate of a second control signal of a first integrated switch of the plurality of integrated switches as a function of whether the external switch is present.

33. The method of claim 19, wherein the system further comprises a capacitor external to the integrated circuit coupled between a gate terminal and another terminal of the external switch.

34. The method of claim 19, further comprising driving a gate terminal of the external switch with a driver, wherein the driver includes a negative supply rail.

35. The method of claim 19, further comprising driving a gate terminal of the external switch with a driver, wherein the driver is electrically coupled closely to a source terminal of the external switch.

36. The method of claim 19, further comprising:
driving a gate terminal of the first integrated switch with a first driver; and
driving a gate terminal of the external switch with a second driver;
wherein the second driver is substantially smaller than the first driver.
